(19) United States
(12) Patent Application Publication
(10) Pub. No.: US 2026/0142064 A1
(43) Pub. Date: May 21, 2026

(54) SLITTED MAGNET FOR SELECTIVE COERCIVITY, AND METHODS THEREOF

(71) Applicant: Tesla, Inc., Austin, TX (US)

(72) Inventors: Ethan Filip, Indian Trail, NC (US); Christian Dinca, Los Altos Hills, CA (US)

(21) Appl. No.: 19/120,680

(22) PCT Filed: Oct. 31, 2023
(86) PCT No.: PCT/US2023/036392

§ 371 Date: Apr. 11, 2025

Related U.S. Application Data
(60) Provisional application No. 63/381,917, filed on Nov. 1, 2022.

(51) Int. Cl. H01F 7/02; H01F 41/02; H02K 1/27

(52) U.S. Cl. CPC H01F 7/0205; H01F 41/0253; H02K 1/27

(57) ABSTRACT

Doped magnets, and methods of manufacture, that include a magnet volume comprising a magnet material and a dopant element; and a cavity (530) positioned within the magnet volume are described. The utilization of a cavity enables the doped magnet to reach desired coercivities with reduced use of doping material (434) and without comprising structural integrity of the doped magnet.

### INCORPORATION BY REFERENCE TO ANY PRIORITY APPLICATIONS

Any and all applications for which a foreign or domestic priority claim is identified in the Application Data Sheet or PCT Request as filed with the present application are hereby incorporated by reference under 37 CFR 1.57, and Rules 4.18 and 20.6. The present application claims priority to U.S. Provisional Patent Application No. 63/381,917, filed Nov. 1, 2022, the disclosure of which is incorporated herein by reference in its entirety and for all purposes.

### BACKGROUND

### Field

The present disclosure relates generally to magnets, and specifically to improved magnets doped with a diffusion material.

### Description of the Related Art

Magnet type motors, generators, or rotors may be employed to power various devices or vehicles. Specifically, electric vehicles may utilize magnetic motors and generators to provide power with efficiency. Typically, magnets are manufactured by pressing, sintering and machining a magnet material to form a magnet, which may be doped using a doping process (e.g., grain boundary diffusion (GBD). Heavy rare earth metals are typically used as a diffusion material in the production of magnets for increasing the coercivity. Coercivity, also called magnetic coercivity, coercive force and coercive field, is a property of a magnet that represents the amount of demagnetizing force needed to reduce the induction of the magnet after the magnet has been magnetized.

In order to sufficiently dope magnets with a diffusion material for increasing coercivity, the magnet is cut completely through (e.g., cut a base block through its middle) to form two smaller block pieces, and apply a dopant onto all surfaces of the magnet pieces such that the dopant may be more easily and extensively diffused into the magnet material to obtain a desired level of coercivity. Once diffusion is complete, the magnet may be adhered (e.g., glued) back together to form a doped magnet with an adhesive layer disposed therebetween such that the magnetic material is not contiguous. An example of such a GBD doping process using doping materials is illustrated in FIG. 1, where a base block magnet 202 is cut 204 through into magnet piece 206-A and magnet piece 206-B before the GBD process 208 is performed to diffuse doping elements (e.g., Terbium (Tb) and/or Dysprosium (Dy)) to form doped magnet pieces 210-A and 210-B. The doped magnet pieces 210-A and 210-B are ground 210 to form ground magnet pieces 212-A and 212-B that are glued 216 back together to form a doped magnet 218.

However, it may be desirable to reduce or minimize the amount of heavy rare earth metals utilized in manufacturing doped magnets, minimize the use of manufacturing steps that require larger size tolerances, and reduce the structural integrity of the doped magnet. For example, cutting through and applying the correct amount of glue to a magnet with accuracy may be challenging, and thereby increases the mechanical tolerances associated with manufacturing a doped magnet.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, a process of manufacturing a doped magnet is provided. The process includes forming a cavity within a magnet to form a processed magnet, wherein the cavity includes a cavity surface and the processed magnet includes an exterior surface; applying a doping material including a dopant element to the cavity surface to form a coated magnet; and processing the coated magnet to form the doped magnet.

In some embodiments, the process further includes applying the doping material to the exterior surface. In some embodiments, forming the cavity includes cutting the cavity into the magnet. In some embodiments, the process further includes grinding the magnet prior to forming the cavity within the magnet. In some embodiments, the process further includes packaging the doped magnet. In some embodiments, the dopant element is selected from a group consisting of Terbium, Dysprosium, and combinations thereof. In some embodiments, the processed magnet includes a contiguous magnet volume. In some embodiments, the process does not include applying an adhesive to at least one of the processed magnet and the coated magnet. In some embodiments, forming the cavity does not include dividing the magnet into a plurality of separate magnet pieces. In some embodiments, heating the coated magnet diffuses the dopant element into the coated magnet. In some embodiments, the dopant element is diffused into the coated magnet through the cavity surface and the exterior surface. In some embodiments, the processed magnet includes at least one additional cavity. In some embodiments, processing includes heating the coated magnet.

In a second aspect, a doped magnet is provided. The coated magnet includes a magnet volume including a magnet material and a dopant element; and a cavity positioned within the magnet volume.

In some embodiments, a width of the cavity is about 0.2-1.5 mm. In some embodiments, the cavity is a slit. In some embodiments, a first proximal end of the cavity extends from a first surface of the magnet volume and a first distal end of the cavity ends within the magnet volume. In some embodiments, a second proximal end of the cavity extends from a second surface of the magnet volume and a second distal end of the cavity ends at a third surface of the magnet volume. In some embodiments, the magnet material is a neodymium magnet. In some embodiments, the doped magnet includes about 0.3-0.8 wt. % of the dopant element. In some embodiments, the doped magnet does not include an adhesive. In some embodiments, the magnet volume is contiguous.

In a third aspect, a rotor is provided. The rotor includes the doped magnet.

In a fourth aspect, an electric vehicle is provided. The electric vehicle includes the rotor.

### BRIEF DESCRIPTION OF THE DRAWINGS

These and other features, aspects, and advantages of the present disclosure are described with reference to the drawings of certain configurations, which are intended to schematically illustrate certain configurations and not to limit the disclosure.

FIG. 1 is a flow chart illustrating an example method of doping a magnet.

FIG. 2 is a flow chart depicting an example method for forming a doped magnet, according to some embodiments.

FIG. 3 is a flow chart illustrating an example method for manufacturing a doped magnet, according to some embodiments.

FIG. 4 is a cross-sectional illustration of a coated magnet, according to some embodiments.

FIG. 5 is a cross-sectional schematic of a rotor, according to some embodiments.

FIGS. 6A-6E are cross-sectional schematics of doped magnets with example dimensions and sizes, according to some embodiments.

FIG. 7 is a perspective view photograph of doped magnets comprising slits, according to some embodiments.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations, in turn, in a manner that may be helpful in understanding certain embodiments; however, the order of description should not be construed to imply that these operations are order-dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

The present disclosure generally relates to forming (e.g., cutting) a cavity (e.g., slit) into a magnet and applying doping material to one or more surfaces of the magnet and/or within the cavity to form a doped magnet (e.g., selectively coerced magnet, or eddy current slit reduced magnet). A dopant (i.e., diffusion material) of the doping material may be incorporated into the magnet through diffusion (e.g., grain boundary diffusion (GBD)). Advantageously, use of the cavity may enable the doped magnet to be sufficiently doped such that the doped magnet reaches the desired coercivity with a reduced amount of doping material utilized. Furthermore, the use of the cavity may also enable increased structural integrity of the doped magnet and/or improved size tolerances, as well as decrease manufacturing difficulty, cost and tolerances. As such, one or more aspects of the present disclosure relates to systems and methods for reducing the usage of heavy rare earth materials in a magnet without incurring significant manufacturing process changes, thereby easing restraints on the use of magnetic materials when they are of a limited supply.

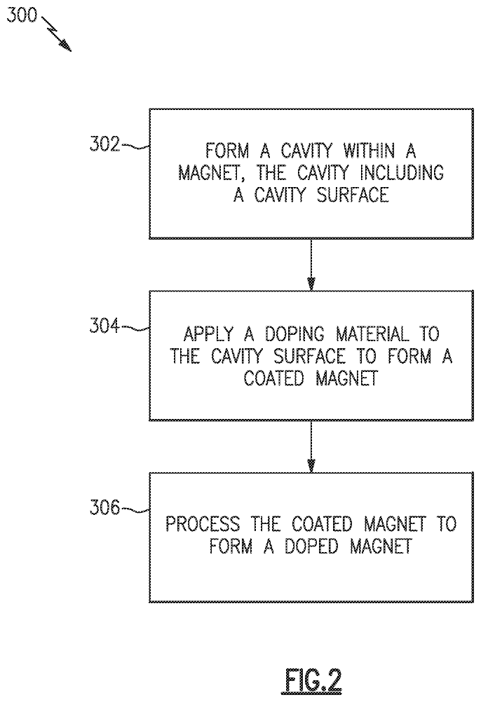

Some embodiments of the present disclosure implement a process of manufacturing a doped magnet that achieves desired coercivity and reduced usage of heavy rare earth materials while preserving structural integrity of the doped magnet without incurring significant manufacturing process changes or additional costs. FIG. 2 depicts an example method 300 for forming a doped magnet. A cavity is formed within a magnet 302, wherein the cavity includes a cavity surface. A doping material is then applied to the cavity surface to form a coated magnet 304. The coated magnet is then processed to form a doped magnet 306.

A magnet used to form the doped magnet may be a ferrite magnet, a gallium magnet, a boron magnet, a nickel magnet, an alnico magnet, a rare earth magnet (e.g., a neodymium magnet, a samarium-cobalt magnet), or combinations thereof. In some embodiments, the magnet includes a magnet material comprising at least one of Fe, Nd, Ga, B, Co, Al, Ni and Sm. In some embodiments, the magnet has various shapes, sizes, and/or dimensions. For example, the magnet may be a cube, a cuboid, a cylinder, other geometric shapes, other customized shapes, and or other shapes. In some embodiments, the magnet includes a contiguous magnet volume such that all of the magnet material of the magnet is a single contiguous piece of material without another material separating the magnet into a plurality of pieces. For example, an adhesive material (e.g., glue, or the like) does not divide the magnet into two distinct pieces or regions. In some embodiments, the magnet does not include an adhesive.

The cavity is formed within the magnet by cutting the cavity into the magnet to form a processed magnet. In some embodiments, the cavity is formed by cutting (e.g., using a wire cutter), drilling, chiseling, grinding, or a combination thereof. In some embodiments, the processed magnet includes a single cavity or a plurality of cavities (e.g., a first cavity and at least one additional cavity). In some embodiments, the processed magnet includes 1, 2, 3, 4, 5, 6, 7, 8, 9 or 10 cavities. In some embodiments, prior to forming the cavity within the magnet, the magnet is ground. In some embodiments, the magnet may be ground to suitable dimension(s) for forming the cavity. In some embodiments, forming the cavity within the processed magnet does not include dividing the magnet into a plurality of separate magnet pieces. In some embodiments, the processed magnet includes a contiguous magnet volume (e.g., without the structural integrity of the processed magnet being compromised) such that all of the magnet material of the processed magnet is a single contiguous piece of material without another material or cavity separating the processed magnet into a plurality of pieces. For example, an adhesive material (e.g., glue, or the like) does not divide the processed magnet into two distinct pieces or regions. In some embodiments, the processed magnet does not include an adhesive.

The number, location, and dimension of the cavity formed into a processed magnet can vary. In some embodiments, a cavity may be formed around the middle or center, or toward the top, bottom, or sides of a processed magnet, or any combination thereof. In some embodiments, some or all of the cavities which are formed differ or are similar in size and dimension. In some embodiments, at least two cavities are formed at symmetric locations around a center of a processed magnet.

A width of a cavity is a dimension of the cavity measured on the surface of the magnet. In some embodiments, a cavity formed has a width of, of about, of at least, or of at least about, 0.05 mm, 0.07 mm, 0.09 mm, 0.1 mm, 0.11 mm, 0.13 mm, 0.15 mm, 0.17 mm, 0.19 mm, 0.2 mm, 0.21 mm, 0.25 mm, 0.5 mm, 0.75 mm, 1 mm, 1.25 mm, 1.5 mm, 2 mm, 2.5 mm, 3 mm, 3.5 mm, 4 mm, 4.5 mm or 5 mm, or any range of values therebetween. A depth of the cavity is a dimension of the cavity measured from the surface of the magnet into the volume of the magnet. In some embodiments, a depth of a cavity within the volume of a processed magnet is of, of about, of at least, or of at least about, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm or 10 mm, or any range of values therebetween. In some embodiments, a length of a processed magnet is of, of about, of at least, or of at least about 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm or 30 mm, or any range of values therebetween. In some embodiments, the height of the processed magnet is of, of about, of at least, or of at least about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm or 25 mm, or any range of values therebetween.

In some embodiments, the cavity has various sizes and/or shapes (e.g., a slit, a cylinder, a cube, a cuboid, or the like). Advantageously, the cavity may increase surface area for diffusing a dopant element of the doping material. In some embodiments, a proximal end of the cavity extends from a surface of a magnet volume and a distal end of the cavity ends within the magnet volume. In some embodiments, the proximal end of the cavity extends from a first surface of a magnet volume and a distal end of the cavity ends at a second surface of the magnet volume. In some embodiments, for example such as a slit, a first proximal end and a first distal end of the cavity extends from a surface of the magnet volume to within the magnet volume, and a second proximal end and a second distal end of the cavity extends from a second surface of the magnet volume to a third surface of the magnet volume. In some embodiments, the size (e.g., width, length, or height) of a cavity can be adjusted based on the size of the magnet that is to be partially cut. For example, the size of the cavity may increase as the size of a processed magnet increases.

In some embodiments, the doping material includes a dopant element. In some embodiments, the doping element is selected from Tb (Terbium), Dy (Dysprosium), and combinations thereof. In some embodiments, the doping material includes a dopant compound. In some embodiments, the dopant compound is selected from (NdₓD_{y})₂Fe₁₄B, Dy₂O₃, DyF₃, TbF₃, or combinations thereof. In some embodiments, the doping material is in the form of a slurry. In some embodiments, the doping material slurry includes solvent and the dopant element and/or dopant compound.

A coated magnet is formed by applying the doping material to the processed magnet. In some embodiments, the doping material is applied to the cavity (e.g., cavity surface) and/or an exterior surface of a processed magnet. In some embodiments, the doping material may be applied by spinning, coating, pasting, or sputtering. In some embodiments, the coated magnet includes a contiguous magnet volume (e.g., without the structural integrity of the magnet being compromised) such that all of the magnet material of the coated magnet is a single contiguous piece of material without another material or cavity separating the coated magnet into a plurality of pieces. For example, an adhesive material (e.g., glue, or the like) does not divide the coated magnet into two distinct pieces or regions. In some embodiments, the coated magnet does not include an adhesive.

Processing the coated magnet forms the doped magnet. In some embodiments, processing the coated magnet includes heating the coated magnet. In some embodiments, heating is performed at a temperature of, of about, of at least, or of at least about, 350° C., 400° C., 450° C., 500° C., 550° C., 600° C., 650° C., 700° C., 750° C., 800° C., 850° C., 900° C., 950° C., 1000° C., 1200° C., 1500° C. or 2000° C., or any range of values therebetween. In some embodiments, heating is performed under a vacuum, an oxidizing gas environment (e.g., O₂) or an inert gas environment. In some embodiments, processing the coated magnet is configured to diffuse the dopant element into the coated magnet to form the doped magnet. In some embodiments, the dopant element is diffused into the coated magnet through the cavity surface and/or the exterior surface of the magnet.

In some embodiments, the doped magnet includes a magnet volume and a cavity positioned within the magnet volume. In some embodiments, the magnet volume includes a magnet material and a dopant element. In some embodiments, a doped magnet is a ferrite magnet, an alnico magnet, a gallium magnet, a boron magnet, a nickel magnet, a rare earth magnet (e.g., a neodymium magnet, a samarium-cobalt magnet), or combinations thereof. In some embodiments, the magnet material comprises at least one of Fe, Nd, Ga, B, Co, Al, Ni and Sm. In some embodiments, the magnet volume is contiguous such that all of the magnet material of the doped magnet is a single contiguous piece of material without another material or cavity separating the magnet into a plurality of pieces. In some embodiments, the dopant element is selected from a group consisting of Tb, Dy, and combinations thereof. In some embodiments, the doped magnet comprises of, of about, of at least, or of at least about 0.05 wt. %, 0.1 wt. %, 0.15 wt. %, 0.2 wt. %, 0.25 wt. %, 0.3 wt. %, 0.4 wt. %, 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. % or 2 wt. % of the dopant element, or any range of values therebetween. In some embodiments, the doped magnet does not comprise an adhesive. In some embodiments, forming the doped magnet does not include applying an adhesive (e.g., glue, or the like) to at least one of the magnet, the processed magnet and the coated magnet. Advantageously, the cost and time associated with forming the doped magnet may be reduced. In some embodiments, the doped magnet is packaged and/or tested after being formed. For example, the doped magnet is packaged for shipment.

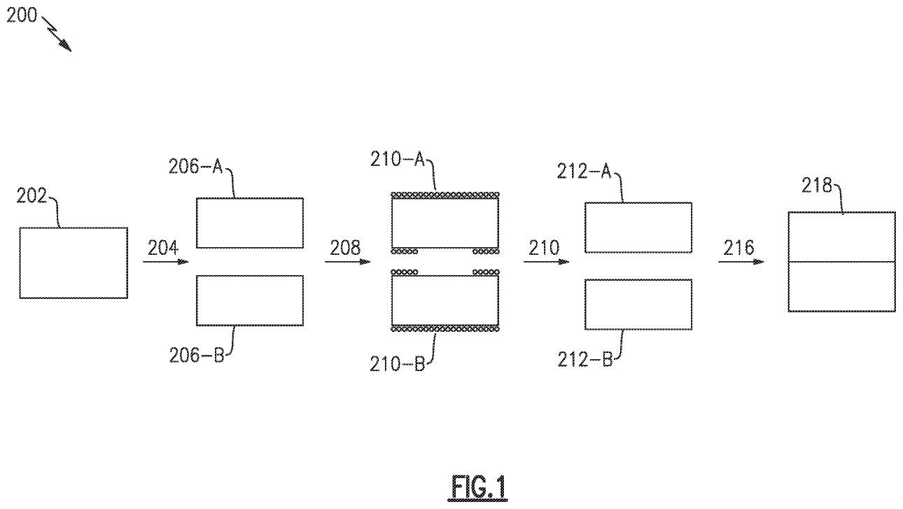

Advantageously, the dopant element may be more easily diffused to form the doped magnet through additional surfaces associated with one or more cavities formed in a coated magnet. Further, structural integrity of the doped magnet may not be compromised as the magnet volume is contiguous and was not cut completely through. Additionally, cost and time for manufacturing the doped magnet may decrease compared with a manufacturing process (e.g., FIG. 1) where a magnet is cut through because, for example, gluing magnet blocks back or grinding surfaces where cut-through were applied are not necessary.

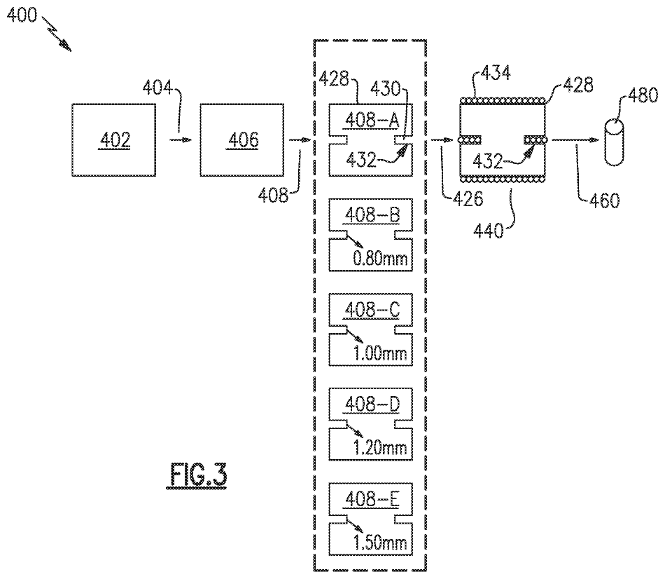

FIG. 3 illustrates an example method 400 for manufacturing a doped magnet. A base magnet block 402 is provided, and grinding 404 is performed on the base magnet block 402 to form a magnet 406 with suitable dimensions. The magnet 406 is slotted 408 to form a cavity 430 within the magnet 406 to obtain a processed magnet 408-A. The cavity 430 includes one or more cavity surfaces 432 and an exterior surface 428 of the processed magnet 408-A. The cavity 430 has a shape of a slit and is formed around the center/middle of the magnet 406 to result in the processed magnet 408-A.

As illustrated by the processed magnets 408-B, 408-C, 408-D, and 408-E, the cavity 430 has a shape of a slit, where a width of the slit can vary. For example, the processed magnet 408-B illustrates that the cavity 430 has a width of 0.80 millimeter, the processed magnet 408-C illustrates that the cavity 430 has a width of 1.00 millimeter, the processed magnet 408-D illustrates that the cavity 430 has a width of 1.20 millimeter, and the processed magnet 408-E illustrates that the cavity 430 has a width of 1.50 millimeter.

During the GBD 426, the doping material 434 is applied to the cavity surface(s) 432 and the exterior surface 428 of the processed magnet 408-A to form a coated magnet 440. Doping material 434 is diffused into the coated magnet 440 during GBD 426 (e.g., by heating) to form a doped magnet (not shown in FIG. 3). The doped magnet is tested 460 and or packaged to form the magnet 480 that is shipped.

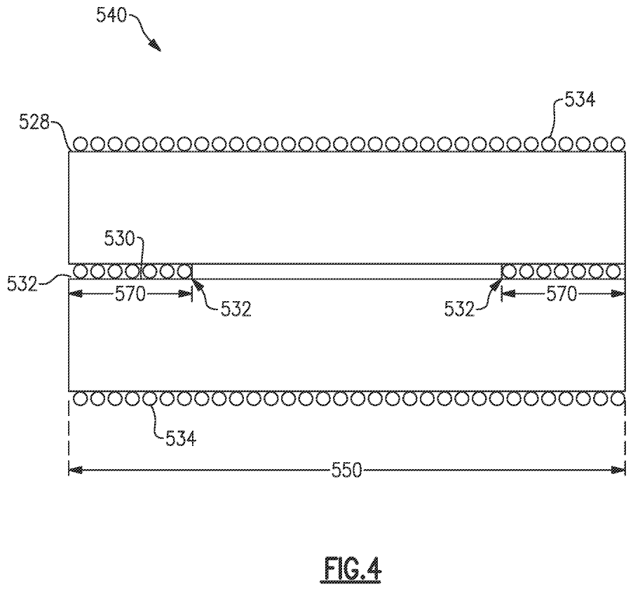

FIG. 4 shows a cross-sectional view of a coated magnet 540. The coated magnet 540 is coated with the doping material 534, where the doping material 534 is coated on one or more cavity surfaces 532 of the cavity 530 and the exterior surface 528. The cavity 530 has a depth 570. The coated magnet 540 has a length 550.

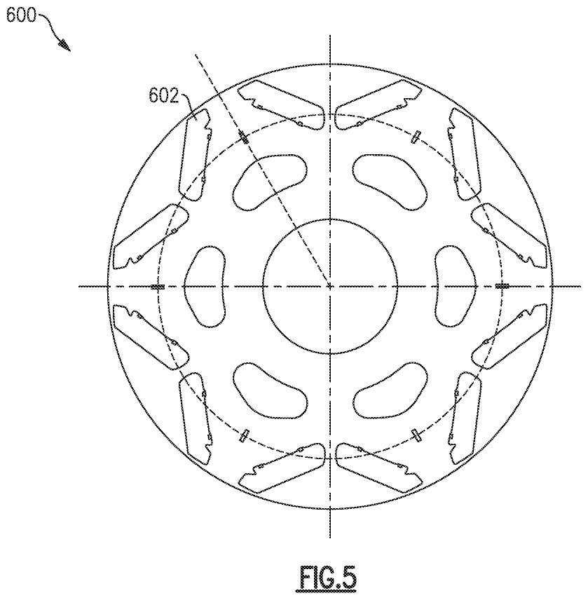

FIG. 5 illustrates a cross-sectional schematic view of a rotor 600. As shown in FIG. 5, the rotor 600 has a plurality of holes including at least a hole 602, where the hole 602 can allow a doped magnet (e.g., the doped magnets 700A-700E) to fit, assembled, and/or integrated with the rotor 600. In some embodiments, the rotor may be assembled and/or integrated as a part of an electric motor and/or vehicle. A doped magnet as described herein may be more accurately matched to fit within the hole 602 because the doped magnet was not cut through as compared to other processes (e.g., shown in FIG. 1), thereby reducing the rate of magnets being too small or too large for the tolerances of the rotor. As such, the doped magnets as described herein may be advantageously more accurately fit and assembled into a rotor.

### Examples

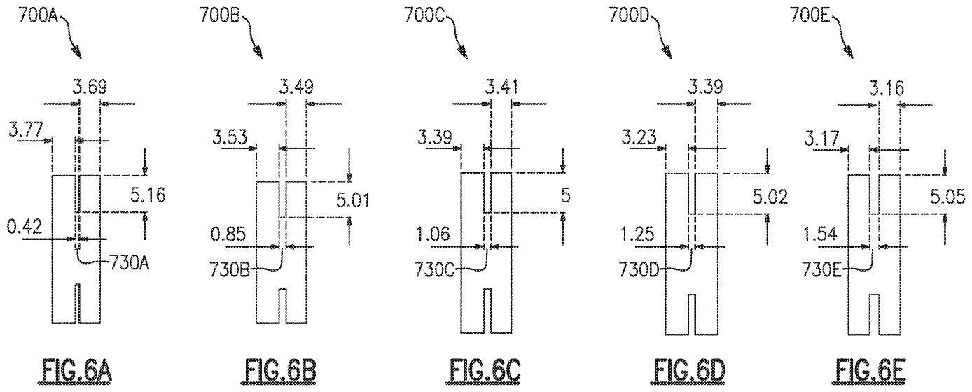

FIGS. 6A-6E show cross-sectional schematics of doped magnets 700A-700E with example dimensions/sizes. As shown in FIG. 6A, the doped magnet 700A included a cavity 730A in the shape of a slit, where the slit width was 0.42 mm and the slit depth was 5.16 mm. A bottom portion of the doped magnet proximal to the slit had a width of 3.77 mm, a top portion of the doped magnet distal to the slit had a width of 3.69 mm, and the total width of the doped magnet 700A was about 7.88 mm (i.e., 0.42 mm+3.77 mm+3.69 mm). As shown in FIG. 6B, the doped magnet 700B included a cavity 730B in the shape of a slit, where the slit width was 0.85 mm and the slit depth was 5.01 mm. A bottom portion of the doped magnet proximal to the slit had a width of 3.53 mm, a top portion of the doped magnet distal to the slit had a width of 3.49 mm, and the total width of the doped magnet 700B was around 7.87 mm (i.e., 0.85 mm+3.53 mm+3.49 mm). As shown in FIG. 6C, the doped magnet 700C included a cavity 730C in the shape of a slit, where the slit width was 1.06 mm and the slit depth was 5.00 mm. A bottom portion of the doped magnet proximal to the slit had a width of 3.39 mm, a top portion of the doped magnet distal to the slit had a width of 3.41 mm, and the total width of the doped magnet 700C was around 7.86 mm (i.e., 1.06 mm+3.39 mm+3.41 mm). As shown in FIG. 6D, the doped magnet 700D included a cavity 730D in the shape of a slit, where the slit width was 1.25 mm and the slit depth was 5.02 mm. A bottom portion of the doped magnet proximal to the slit had a width of 3.23 mm, a top portion of the doped magnet distal to the slit had a width of 3.39 mm, and the total width of the doped magnet 700D was around 7.87 mm (i.e., 1.25 mm+3.23 mm+3.39 mm). As shown in FIG. 6E, the doped magnet 700E included a cavity 730E in the shape of a slit, where the slit width was 1.54 mm and the slit depth was 5.05 mm. A bottom portion of the doped magnet proximal to the slit had a width of 3.17 mm, a top portion of the doped magnet distal to the slit had a width of 3.16 mm, and the total width of the doped magnet 700E was around 7.87 mm (i.e., 1.54 mm+3.17 mm+3.16 mm).

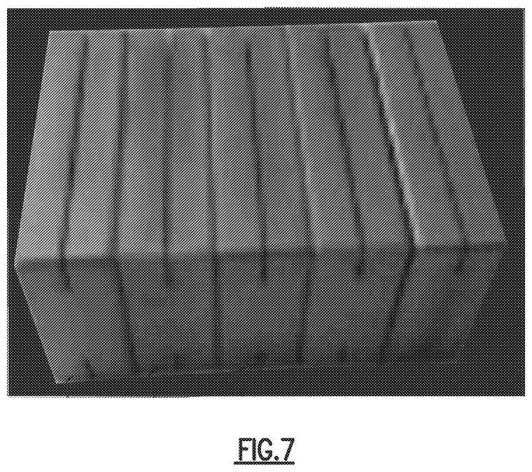

FIG. 7 illustrates perspective view of doped magnets comprising slits, whereby each doped magnet was not cut completely through.

Table 1 shows example width and a weight percentages of doped neodymium magnets #1-#5 that were formed from a magnet with a length of about 20.5 mm and a height of about 7.9 mm, and a slit depth of 5 mm with various slit widths shown in Table 1 formed using a wire cutter. The width refers to a slit width of the cavity, and the weight percentage refers to the doping amount of a Tb dopant element within the composition of the doped magnets. A doping material comprising Tb was applied to the surfaces of the processed magnet and cavity, and the coated magnet is processed to form a doped magnet. In Table 1, each of doped magnets #1-#5 were found to have similar coercivities. As illustrated in Table 1, adjusting the width of the cavity can be adjusted to affect an amount of Tb needed to reach desired doping level of about 5% and therefore the desired coercivities.

TABLE 1

| | #1 | #2 | #3 | #4 | #5 |
|---|---|---|---|---|---|
| Slit Width | 0.4 | 0.8 | 1 | 1.2 | 1.5 |
| (mm) | | | | | |
| Tb wt. % | 0.58 | 0.61 | 0.62 | 0.62 | 0.64 |

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of customer computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable customer computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code that include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

1. A process of manufacturing a doped magnet, comprising:
forming a cavity within a magnet to form a processed magnet, wherein the cavity comprises a cavity surface and the processed magnet comprises an exterior surface;
applying a doping material comprising a dopant element to the cavity surface to form a coated magnet; and
processing the coated magnet to form the doped magnet.

2. The process of claim 1, further comprising applying the doping material to the exterior surface.

3. The process of claim 1, wherein forming the cavity comprises cutting the cavity into the magnet.

4. The process of claim 1, further comprising grinding the magnet prior to forming the cavity within the magnet.

5. The process of claim 1, further comprising packaging the doped magnet.

6. The process of claim 1, wherein the dopant element is selected from a group consisting of Terbium, Dysprosium, and combinations thereof.

7. The process of claim 1, wherein the processed magnet comprises a contiguous magnet volume.

8. The process of claim 1, wherein the process does not include applying an adhesive to at least one of the processed magnet and the coated magnet.

9. The process of claim 1, wherein forming the cavity does not include dividing the magnet into a plurality of separate magnet pieces.

10. The process of claim 1, wherein heating the coated magnet diffuses the dopant element into the coated magnet.

11. The process of claim 10, wherein the dopant element is diffused into the coated magnet through the cavity surface and the exterior surface.

12. The process of claim 1, wherein the processed magnet comprises at least one additional cavity.

13. The process of claim 1, wherein processing comprises heating the coated magnet.

14. A doped magnet, comprising:
a magnet volume comprising a magnet material and a dopant element; and
a cavity positioned within the magnet volume.

15. The doped magnet of claim 14, wherein a width of the cavity is about 0.2-1.5 mm.

16. The doped magnet of claim 14, wherein the cavity is a slit.

17. The doped magnet of claim 14, wherein a first proximal end of the cavity extends from a first surface of the magnet volume and a first distal end of the cavity ends within the magnet volume.

18. The doped magnet of claim 14, wherein a second proximal end of the cavity extends from a second surface of the magnet volume and a second distal end of the cavity ends at a third surface of the magnet volume.

19. The doped magnet of claim 14, wherein the magnet material is a neodymium magnet.

20. The doped magnet of claim 14, wherein the doped magnet comprises about 0.3-0.8 wt. % of the dopant element.

21. The doped magnet of claim 14, wherein the doped magnet does not comprise an adhesive.

22. The doped magnet of claim 14, wherein the magnet volume is contiguous.

23. A rotor comprising the doped magnet of claim 14.

24. An electric vehicle comprising the rotor of claim 23.
